(19) United States
(12) Patent Application Publication
(10) Pub. No.: US 2017/0341254 A1
(43) Pub. Date: Nov. 30, 2017

(54) CUTTING APPARATUS

(71) Applicant: DISCO CORPORATION, Tokyo (JP)

(72) Inventors: Takaaki Inoue, Tokyo (JP); Masao Nozaki, Tokyo (JP)

(21) Appl. No.: 15/603,644

(22) Filed: May 24, 2017

(30) Foreign Application Priority Data
May 31, 2016 (JP) 2016-108243

(51) Int. Cl. B26D 7/18; B26D 7/01; B26D 5/00

(52) U.S. Cl. CPC B26D 7/1863; B26D 5/007; B26D 7/018

(57) ABSTRACT

A cutting apparatus includes a chuck table for holding a workpiece, a cutting blade for cutting the workpiece which is held by the chuck table, and a blade cover disposed in covering relation to an outer circumference of the cutting blade. The workpiece is cut in a dry state by the cutting blade while cut dusts produced from the workpiece and rotating with the cutting blade are being discharged through a tubular member under suction by a cut dusts retrieving unit mounted on the blade cover.

### BACKGROUND OF THE INVENTION

### Field of the Invention

The present invention relates to a cutting apparatus that is provided with a blade cover for a cutting blade.

### Description of the Related Art

Workpieces including semiconductor wafers with devices such as integrated circuits (ICs) formed on their surfaces and packaged substrates with a plurality of device dusts sealed thereon by resin layers are cut into individual dusts by the annular cutting blade of a cutting apparatus. Normally, the annular cutting blade of the cutting apparatus has its outer circumference covered with a blade cover having nozzles for ejecting cutting water. While the cutting apparatus of this type is cutting a workpiece, the nozzles supply cutting water to the cutting blade and the workpiece to cool the frictional heat generated at the point where the workpiece is cut and also to clean the surface of the workpiece (see, for example, Japanese Patent Laid-Open No. 2015-145046).

### SUMMARY OF THE INVENTION

Some workpieces which are made of resins that absorb water and green ceramics prior to being sintered should be kept out of contact with water. Such workpieces need to be cut by a cutting blade while they are being kept dry without being supplied with cutting water. However, when a dry workpiece is cut by a cutting blade, cut dusts tend to scatter backwards as contaminants due to the rotation of the cutting blade and spread into a wide area. The contaminants are likely to be deposited on the upper surface of the workpiece being cut, contaminating the workpiece, and to be applied to various parts of the cutting apparatus, making it hard for the operator to perform its maintenance task.

It is an object of the present invention to provide a cutting apparatus which is capable of reducing the contamination of a workpiece when it is cut in a dry state and of making its maintenance task simple and efficient.

In accordance with an aspect of the present invention, there is provided a cutting apparatus including a chuck table for holding a workpiece, a cutting blade for cutting the workpiece which is held by the chuck table, and a blade cover disposed in covering relation to an outer circumference of the cutting blade and having an opening defined in a bottom thereof through which a lower tip end portion of the cutting blade projects, wherein the blade cover includes cut dusts retrieving means for retrieving cut dusts produced from the workpiece, the cut dusts retrieving means being disposed on a side of the blade cover toward which the cut dusts scatter upon rotation of the cutting blade when the workpiece is cut by the cutting blade, the cut dusts retrieving means includes a tubular member having an end joined to a side wall of the blade cover in which a cut dusts discharge opening is defined, and a suction source coupled to the other end of the tubular member, and the workpiece is cut in a dry state by the cutting blade while the cut dusts rotating with the cutting blade in the blade cover are being discharged from the workpiece through the tubular member by actuating the suction source.

With the above arrangement, when the workpiece is cut in a dry state by the cutting blade, the cut dusts from the workpiece are drawn into the blade cover, and rotate with the cutting blade within the blade cover. Once inside the blade cover, the cut dusts are discharged out of the blade cover through the tubular member under suction of the suction source. Consequently, since the cut dusts are less liable to scatter around while the workpiece is being cut by the cutting blade, the deposition of cut dusts as contaminants on the upper surface of the workpiece being cut, and on various parts of the cutting apparatus is reduced, so that the contamination of the workpiece is minimized and the maintenance of the cutting apparatus is made simple and efficient.

Preferably, the blade cover has an air inlet port defined in a bottom thereof between the opening and the cut dusts discharge opening and oriented toward the cut dusts discharge opening, whereby cut dusts which have been left undrawn into the opening are drawn with surrounding air through the air inlet port to the cut dusts discharge opening.

According to the present invention, inasmuch as the cut dusts rotating with cutting blade are discharged out of the blade cover by the suction source, the contamination of the workpiece with cut dusts produced when the workpiece is cut by the cutting blade is minimized, and the maintenance of the cutting apparatus is made simple and efficient.

The above and other objects, features and advantages of the present invention and the manner of realizing them will become more apparent, and the invention itself will best be understood from a study of the following description and appended claims with reference to the attached drawings showing a preferred embodiment of the invention.

### BRIEF DESCRIPTION OF THE DRAWINGS

FIG. 1 is a perspective view of a cutting apparatus according to an embodiment of the present invention;

FIG. 2 is a perspective view of a blade cover according to the embodiment;

FIG. 3A is a fragmentary horizontal cross-sectional view of the blade cover;

FIG. 3B is a vertical cross-sectional view of the blade cover;

FIGS. 4A and 4B are cross-sectional views depicting the relationship between storage spaces in blade covers according to comparative examples and cutting blades; and

FIGS. 5A and 5B are cross-sectional views illustrative of the manner in which the cutting apparatus according to the embodiment carries out a cutting process.

### DETAILED DESCRIPTION OF THE PREFERRED EMBODIMENT

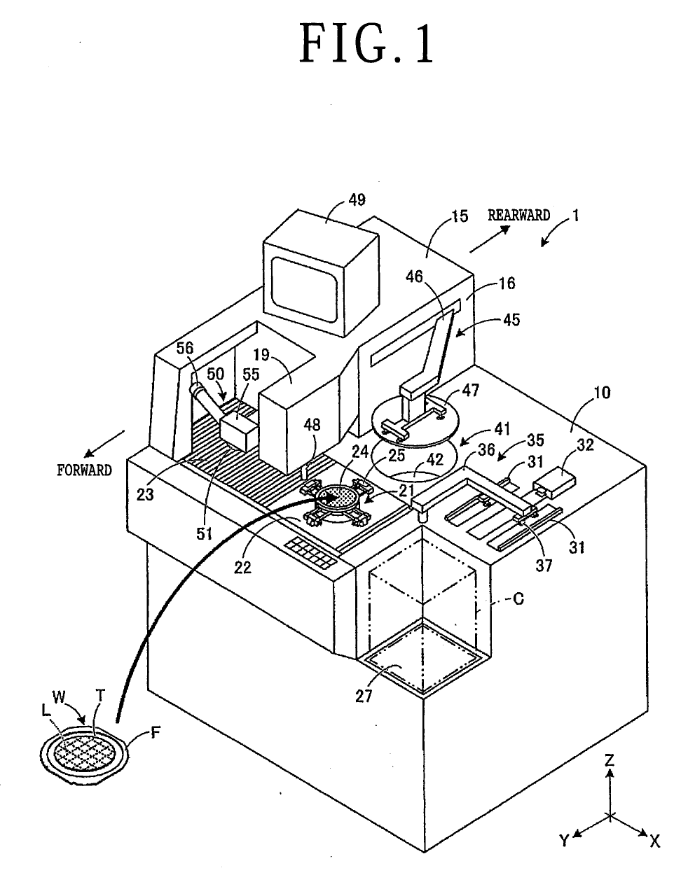

A cutting apparatus according to an embodiment of the present invention will be described below with reference to the accompanying drawings. FIG. 1 depicts in perspective the cutting apparatus, denoted by 1, according to the present embodiment. The principles of the present invention are not limited to the cutting apparatus 1 depicted in FIG. 1, but are also applicable to other cutting apparatus insofar as they are provided with a blade cover according to the present embodiment.

As depicted in FIG. 1, the cutting apparatus 1 is arranged to cut, in a dry state, a plate-shaped workpiece W held on a chuck table 21 with a cutting blade 51 and to retrieve cut dusts produced from the workpiece W when it is cut by the cutting blade 51. The workpiece W has its upper surface demarcated into a plurality of areas by a grid of projected dicing lines L. The workpiece W is loaded into the cutting apparatus 1 while being supported on a ring frame F by a dicing tape T. The workpiece W should preferably be made of a material that can be cut in a dry state without being supplied with cutting water, e.g., a resin that absorbs water or green ceramics prior to being sintered which is formed into a flat plate shape.

The cutting apparatus 1 includes a housing 10 having a rectangular opening defined in its upper wall and extending in X-axis directions. The rectangular opening is covered with a movable plate 22 that is movable with the chuck table 21 and a bellows-like water-resistant cover 23 disposed adjacent to the movable plate 22. The water-resistant cover 23 is disposed over a ball-screw moving mechanism, not depicted, positioned in the housing 10 for moving the chuck table 21 along the X-axis directions. The chuck table 21 has a holding surface 24 on its upper face for holding the workpiece W thereon under suction, and is surrounded by a plurality of clamps 25 for securely gripping the ring frame F disposed around the workpiece W.

The chuck table 21 is moved back and forth between a transfer position at the center of the cutting apparatus 1 and a cutting position facing the cutting blade 51. In FIG. 1, the chuck table 21 is depicted as standing by in the transfer position. The housing 10 has a recessed corner adjacent to the transfer position, and a placement table 27 is vertically movably disposed at the bottom of the recessed corner. The placement table 27 supports thereon a cassette C which houses workpieces W therein. The placement table 27 with the cassette C supported thereon is vertically moved to adjust a vertical position where a workpiece W can be pulled from and pushed into the cassette C.

Behind the placement table 27, there are disposed a pair of centering guides 31 extending parallel to Y-axis directions that are perpendicular to the X-axis directions and a push-pull mechanism 32 for moving a workpiece W between the centering guides 31 and the cassette C. The centering guides 31 guide a workpiece W as it is pulled and pushed by the push-pull mechanism 32 and position the workpiece W with respect to the X-axis directions. The push-pull mechanism 32 pulls a workpiece W to be cut from the cassette C onto the centering guides 31, and pushes a cut workpiece W from the centering guides 31 into the cassette C.

A first feed arm 35 for feeding a workpiece W between the centering guides 31 and the chuck table 21 is provided near the centering guides 31. The first feed arm 35 includes an L-shaped arm member 36 having feed pads 37 on its distal end portion for holding a workpiece W. When the first feed arm 35 is turned about an end thereof, the feed pads 37 feed a workpiece W held thereby to the chuck table 21 or the centering guides 31. A spinner cleaning mechanism 41 is disposed at a position on the housing 10 behind the chuck table 21 in the transfer position. The spinner cleaning mechanism 41 includes a spinner table 42 rotatable about its own axis. The spinner table 42 supports thereon a workpiece W transferred from the first feed arm 35. The spinner cleaning mechanism 41 operates by ejecting cleaning water toward the spinner table 42 that is being rotated to clean the workpiece W supported on the spinner table 42, and thereafter applying drying air to the workpiece W on the spinner table 42, thereby drying the workpiece W.

A support base 15 that supports cutting means 50 provided with the cutting blade 51 is disposed on the housing 10 remotely from the placement table 27, the centering guides 31, and the push-pull mechanism 32. The cutting means 50 has a spindle, not depicted, supported by the support base 15. The cutting blade 51 is mounted on a distal end of the spindle. The cutting blade 51 is made of abrasive grains of diamond that are cemented together into a disk shape by a bonding agent. A moving mechanism, not depicted, for moving the cutting blade 51 in the Y-axis directions and Z-axis directions that are perpendicular to the X-axis directions and the Y-axis directions, respectively, is coupled to the cutting means 50. The cutting means 50 includes a box-shaped blade cover 55 covering an outer circumference of the cutting blade 51, whose lower tip end portion projects downwardly from the blade cover 55.

A second feed arm 45 for feeding a workpiece W between the chuck table 21 and the spinner cleaning mechanism 41 is provided on a side surface 16 of the support base 15. The second feed arm 45 includes an arm member 46 extending obliquely forwardly from the side surface 16 of the support base 15 and having a feed pad 47 on a distal end thereof for holding a workpiece W. When the second feed arm 45 is moved back and forth, the feed pad 47 feeds a workpiece W held thereby between the chuck table 21 and the spinner cleaning mechanism 41. The support base 15 includes a cantilevered support 19 extending over and across the path along which the chuck table 21 moves between the transfer position and the cutting position. The cantilevered support 19 supports an imaging unit 48 for capturing an image of a workpiece W on the chuck table 21. An image captured of a workpiece W on the chuck table 21 by the imaging unit 48 will be used in achieving alignment between the cutting means 50 and the chuck table 21. The support base 15 supports on its upper surface a monitor display 49 for displaying cutting conditions for a workpiece W.

Since the workpiece W should preferably be made of a material which should be kept out of contact with water, the workpiece W is cut in a dry state by the cutting blade 51 without being supplied with ejected cutting water. Generally, when workpieces are cut in a dry state, since cut dusts from the workpieces are not washed away by cutting water which would otherwise be ejected to them, the cut dusts tend to fill spaces in the cutting apparatus as the number of workpieces cut thereby increases. Therefore, the cut dusts floating in the cutting apparatus are likely to be deposited as contaminants on the upper surfaces of workpieces W being cut, contaminating the workpieces, and to be applied to and accumulated on various parts of the cutting apparatus, making it hard for the operator to perform its maintenance task.

With the cutting apparatus 1 according to the present embodiment, the cutting means 50 is arranged to cause the cut dusts to rotate with the cutting blade 51 inside of the blade cover 55, and to retrieve the cut dusts from the blade cover 55 with cut dusts retrieving means 56 provided on the blade cover 55. Consequently, as the cut dusts are discharged from the blade cover 55 by the cut dusts retrieving means 56, the space in the cutting apparatus 1 is prevented from being filled with cut dusts even if the number of workpieces W cut thereby increases. As a result, the deposition of cut dusts as contaminants on the upper surfaces of workpieces W being cut, and on various parts of the cutting apparatus 1 is reduced, so that the contamination of workpieces W cut in a dry state is minimized and the maintenance of the cutting apparatus 1 is made simple and efficient.

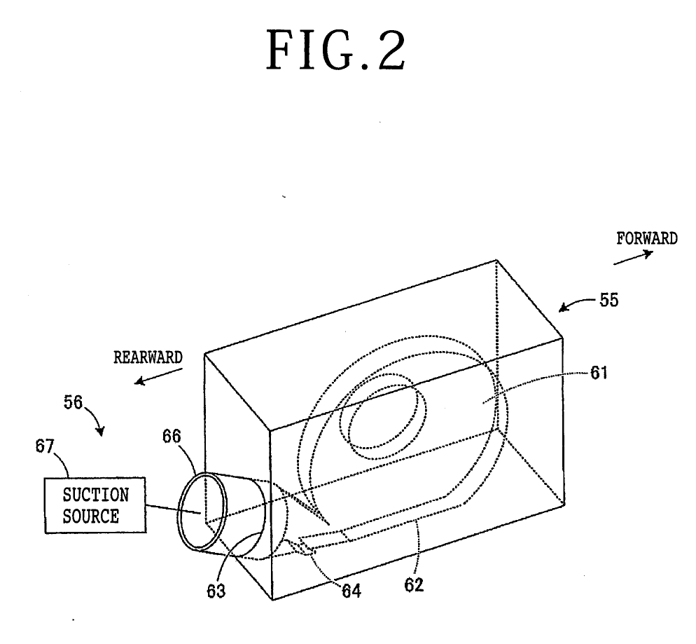

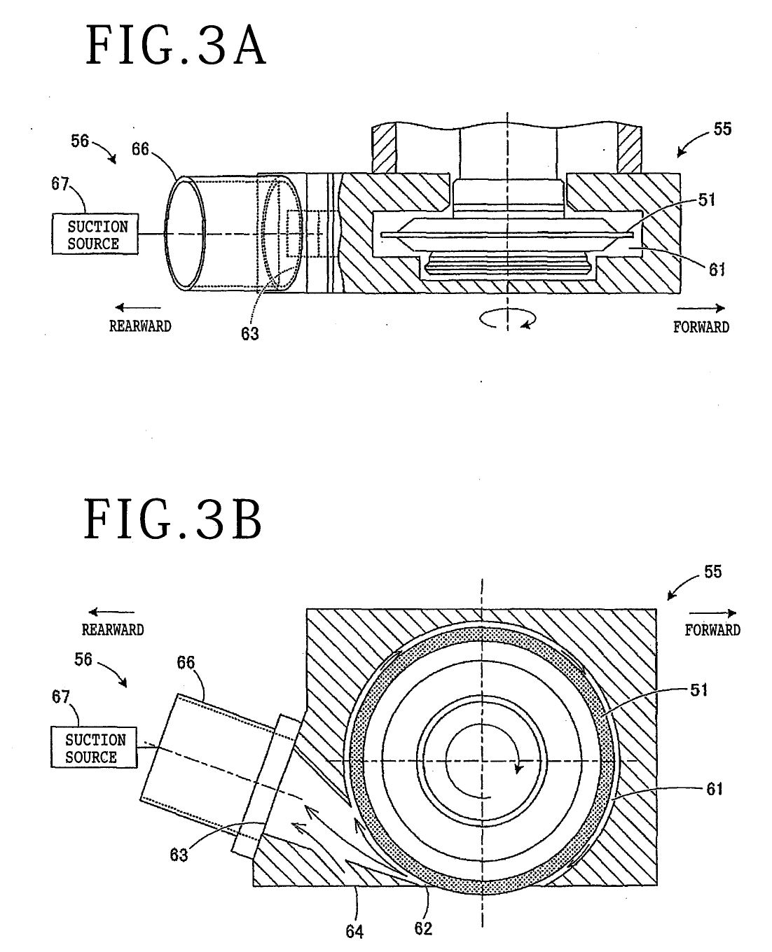

The blade cover 55 according to the present embodiment will be described below with reference to FIGS. 2, 3A, and 3B. FIG. 2 depicts the blade cover 55 in perspective, and FIGS. 3A and 3B depict the blade cover 55 in cross section.

As depicted in FIGS. 2, 3A, and 3B, the blade cover 55 is formed in covering relation to an outer circumference of the cutting blade 51. The cut dusts retrieving means 56 provided on the blade cover 55 is disposed on the side of, or rearwardly of, the cutting blade 51 toward which cut dusts scatter upon rotation of the cutting blade 51 when the workpiece W is cut by the cutting blade 51. Specifically, the blade cover 55 has a storage space 61 defined therein which houses the cutting blade 51 therein, and an opening 62 defined in a bottom thereof through which a lower tip end portion of the cutting blade 51 projects downwardly. In other words, the blade cover 55 is formed in covering relation to an outer circumference and both sides of the cutting blade 51, except the lower tip end portion of the cutting blade 51.

The blade cover 55 also has a cut dusts discharge opening 63 defined in a rear side wall thereof for discharging cut dusts that have entered the storage space 61 toward the cut dusts retrieving means 56. The bottom of the blade cover 55 also has an air inlet port 64 (see FIGS. 2 and 3B) defined therein between the opening 62 and the cut dusts discharge opening 63 and oriented toward the cut dusts discharge opening 63, for introducing air toward the cut dusts discharge opening 63. The cut dusts retrieving means 56 includes a tubular member 66 having an end joined to the outer surface of the rear side wall of the blade cover 55 in fluid communication with the cut dusts discharge opening 63, and a suction source 67 coupled to the other end of the tubular member 66. The suction source 67 should preferably be of the cyclone type. However, it may be of any of various other types insofar as it is capable of drawing in cut dusts from the blade cover 55 through the tubular member 66.

When the workpiece W is cut by the cutting means 50, the suction source 67 is actuated and the cutting blade 51 is rotated about its own axis. Cut dusts produced from the workpiece W by the cutting blade 51 are drawn through the opening 62 into the storage space 61. Because the cutting blade 51 is covered substantially in its entirety by the blade cover 55, as described above, an air flow is developed in the storage space 61 by the rotation of the cutting blade 51. The cut dusts introduced into the storage space 61 are entrained by the air flow, caused to rotate with the cutting blade 51, and drawn through the tubular member 66 toward the suction source 67. Therefore, the workpiece W is cut in a dry state by the cutting blade 51 while cut dusts from the workpiece W are being discharged from the workpieces W.

Other cut dusts from the workpiece W which have not been drawn into the opening 62 are drawn into the air inlet port 64 defined in the bottom of the blade cover 55. Since the cut dusts that have been left undrawn into the opening 62 at the time the workpiece W is cut by the cutting blade 51 are drawn with surrounding air into the air inlet port 64, the cut dusts from the workpiece W are drawn into the two openings, i.e., the opening 62 and the air inlet port 64, so that the amount of cut dusts left removed from the workpiece W is minimized. When the workpiece W is cut in a dry state by the cutting blade 51, therefore, the cut dusts are prevented from being scattered around in a wide area, and hence the deposition thereof on the upper surface of the workpiece W and various parts of the cutting apparatus 1 is minimized.

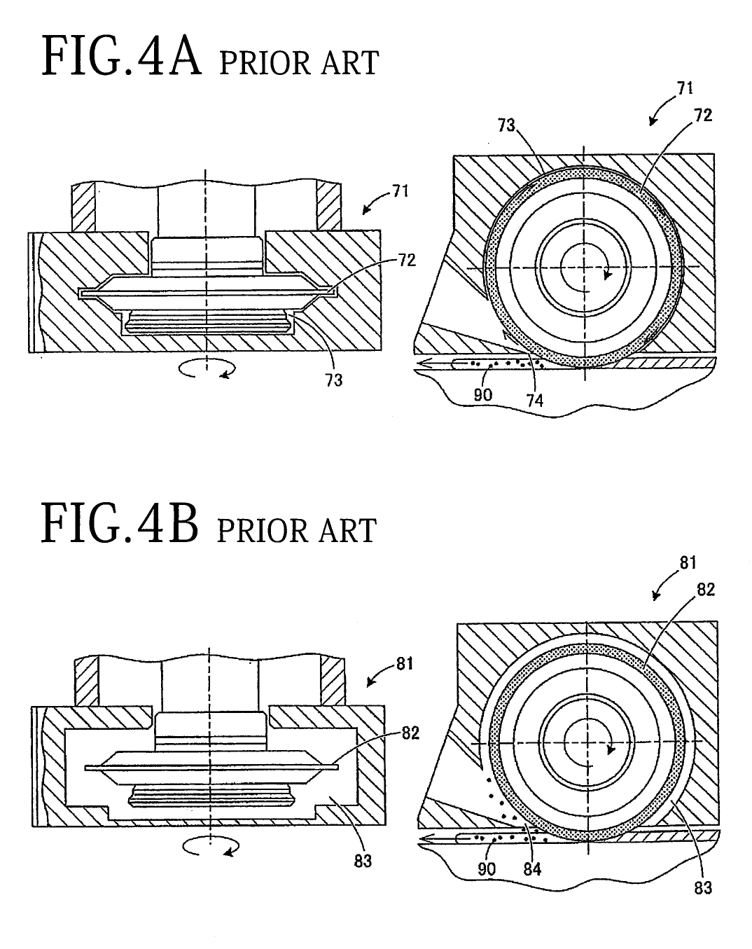

The relationship between the storage space 61 and the cutting blade 51 according to the present embodiment will be described below by way of comparison with comparative examples with reference to FIGS. 4A and 4B. FIGS. 4A and 4B are cross-sectional views depicting the relationship between storage spaces in blade covers according to comparative examples and cutting blades. FIG. 4A illustrates the blade cover according to Comparative Example 1, and FIG. 4B illustrates the blade cover according to Comparative Example 2.

As depicted in FIG. 4A, the blade cover, denoted by 71, according to Comparative Example 1, has a storage space 73 defined therein and storing a cutting blade 72 therein. The storage space 73 is shaped complementarily to the outer shape of the cutting blade 72 housed in the storage space 73. The clearance between the inner surface of the blade cover 71 and the outer surface of the cutting blade 72 is relatively small. Though an air flow is developed in the storage space 73 by the rotation of the cutting blade 72, since the storage space 73 is too small with respect to the cutting blade 72, cut dusts 90 from the workpiece are less liable to enter the storage space 73 through an opening 74 defined in the bottom of the blade cover 71. Therefore, the cut dusts 90 generated from the workpiece when the workpiece is cut by the cutting blade 72 are not likely to be drawn into the blade cover 71, but are scattered rearwardly underneath the blade cover 71.

As depicted in FIG. 4B, the blade cover, denoted by 81, according to Comparative Example 2, has a storage space 83 defined therein and storing a cutting blade 82 therein. The storage space 83 is large relatively to the outer shape of the cutting blade 82 housed in the storage space 83. The clearance between the inner surface of the blade cover 81 and the outer surface of the cutting blade 82 is relatively large. Since the storage space 83 is too large with respect to the cutting blade 82, no air flow is developed in the storage space 83 by the rotation of the cutting blade 82. As cut dusts 90 from the workpiece W are not entrained by an air flow, the cut dusts 90 are less liable to enter the blade cover 81. Therefore, the cut dusts 90 generated from the workpiece W when the workpiece W is cut by the cutting blade 82 are not likely to be drawn into the blade cover 81, but are scattered rearwardly underneath the blade cover 81.

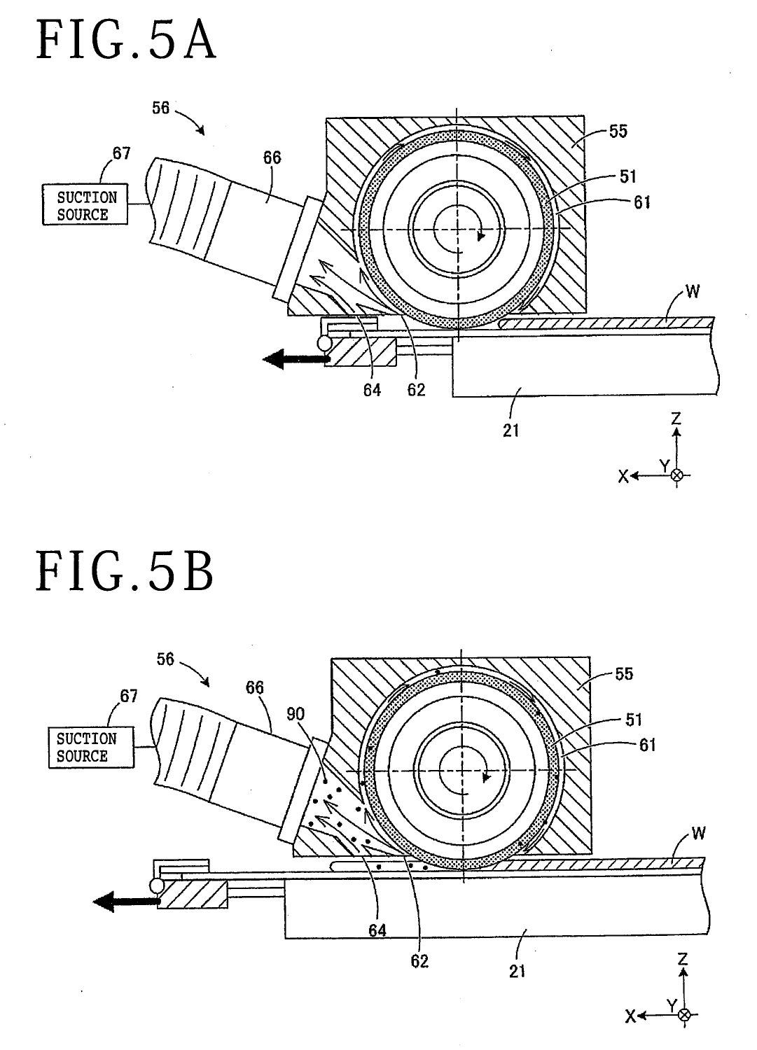

In the blade cover 71 according to Comparative Example 1 depicted in FIG. 4A, the cut dusts 90 are less likely to enter the storage space 73. In the blade cover 81 according to Comparative Example 2 depicted in FIG. 4B, the cut dusts 90 are less likely to be drawn from the storage space 83. The inventors of the present invention have confirmed the manner in which cut dusts are drawn with respect to blade covers and cutting blades of different sizes, and found that the cut dusts 90 are drawn well when they rotate with the cutting blade. According to the present embodiment, the clearance between the inner surface of the blade cover 55 and the outer surface of the cutting blade 51 is adjusted such that the cut dusts 90 rotate with the cutting blade 51 within the storage space 61 (see FIG. 5B).

Unlike general blade covers provided with nozzles, the blade cover 55 for the cutting blade 51 for cutting the workpiece W in a dry state is arranged such that the clearance between the inner surface of the blade cover 55 and the outer surface of the cutting blade 51 is important. According to a general blade cover, since nozzles for ejecting cutting water are positioned laterally of the cutting blade, the side of the cutting blade is exposed outwardly. Therefore, the general blade cover fails to generate an air flow within the blade cover upon rotation of the cutting blade, and is unable to rotate cut dusts with the cutting blade unlike the blade cover 55 according to the present embodiment.

A cutting process carried out by the cutting apparatus 1 according to the present embodiment will be described below with reference to FIGS. 5A and 5B. FIGS. 5A and 5B are illustrative of the manner in which the cutting apparatus 1 according to the embodiment carries out a cutting process. The cutting process to be described below is by way of illustrative example only, and may be changed or modified appropriately.

As depicted in FIG. 5A, when the workpiece W has been held on the chuck table 21 under suction, the chuck table 21 is moved closer to the cutting blade 51. At this time, the cutting blade 51 is rotated about its own axis at a high speed, and the suction source 67 is actuated to develop a negative pressure in the blade cover 55. Radially outwardly of the workpiece W, the cutting blade 51 is positioned in alignment with one of the projected dicing lines L (see FIG. 1) and lowered to a position where it can cut into the workpiece W. The chuck table 21 is then cutting-fed along one of the X-axis directions to the cutting blade 51, which then cuts into the workpiece W along the aligned projected dicing line L.

As depicted in FIG. 5B, when the workpiece W is cut by the cutting blade 51 which is rotating at the high speed, cut dusts 90 are generated from a point where the workpiece W is being cut by the cutting blade 51. At this time, an air flow is generated in the storage space 61 in the blade cover 55 by the rotation of the cutting blade 51, causing the cut dusts 90 to enter the storage space 61 through the opening 62 in the blade cover 55 so that the cut dusts 90 are entrained by the air flow moving along the direction in which the cutting blade 51 is rotating. Once inside the storage space 61, the cut dusts 90 rotate with the cutting blade 51, and are then drawn from the storage space 61 through the tubular member 66 toward the suction source 67.

The blade cover 55 has the air inlet port 64 defined therein rearwardly of the opening 62. Other cut dusts 90 which have been left undrawn through the opening 62 are drawn together with surrounding air through the air inlet port 64 toward the suction source 67. In this manner, the workpiece W is cut in a dry state by the cutting blade 51 while the cut dusts 90 are being discharged from the workpiece W by the blade cover 55. Inasmuch as the cut dusts 90 are thus less liable to scatter around while the workpiece W is being cut by the cutting blade 51, the space in the cutting apparatus 1 is not filled with cut dusts, and the deposition of cut dusts on the workpiece W and various parts of the cutting apparatus 1 is minimized.

As described above, according to the present embodiment, when the workpiece W is cut in a dry state by the cutting blade 51, cut dusts 90 from the workpiece W are drawn into the blade cover 55 and rotate with the cutting blade 51 within the blade cover 55 as the cutting blade 51 rotates. The cut dusts 90 in the blade cover 55 are then discharged out of the blade cover 55 through the tubular member 66 under the suction of the suction source 67. Consequently, since the cut dusts 90 are less liable to scatter around while the workpiece W is being cut by the cutting blade 51, the deposition of cut dusts as contaminants on the upper surface of the workpiece W being cut, and on various parts of the cutting apparatus 1 is reduced, so that the contamination of the workpiece W is minimized and the maintenance of the cutting apparatus 1 is made simple and efficient.

The present invention is not limited to the above illustrated embodiment, but various many changes and modifications may be made in the embodiment. The present invention should not be construed as being restricted to the sizes and shapes depicted in the accompanying drawings, but the illustrated sizes and shapes can be changed or modified within the scope of the present invention. Other structural details illustrated in the embodiment can also be changed or modified within the scope of the present invention.

For example, according to the above embodiment, the storage space 61 defined in the blade cover 55 is substantially of a flat circular shape. However, the storage space 61 is not limited to such a flat circular shape, but may be of any shape as long as it surrounds an outer circumference of the cutting blade 51 except a lower tip end portion thereof and is capable of rotating cut dusts 90 with the cutting blade 51.

In the above embodiment, the blade cover 55 has the air inlet port 64 for introducing cut dusts 90 that have been left undrawn into the opening 62. However, the blade cover 55 may be free of the air inlet port 64.

In the above embodiment, the tubular member 66 joined to the blade cover 55 is not limited to any angle with respect to the blade cover 55. However, the tubular member 66 should preferably be inclined to the holding surface 24 of the chuck table 21 so as to extend along the direction in which the cut dusts 90 are lifted up from the workpiece W.

In the above embodiment, the suction source 67 should preferably be of the cyclone type for developing a negative pressure to draw the cut dusts 90 under suction. However, the suction source 67 is not limited to the cyclone type, but may include an ordinary suction pump or ejector, for example.

As described above, the present invention offers advantages that the cutting apparatus is capable of cutting a workpiece without allowing cut dusts produced therefrom to be deposited on various parts of the cutting apparatus and the workpiece. The principles of the present invention are particularly useful when incorporated in a cutting apparatus for cutting a workpiece made of green ceramics or the like.

The present invention is not limited to the details of the above described preferred embodiment. The scope of the invention is defined by the appended claims and all changes and modifications as fall within the equivalence of the scope of the claims are therefore to be embraced by the invention.

What is claimed is:

1. A cutting apparatus comprising:
a chuck table for holding a workpiece;
a cutting blade for cutting the workpiece which is held by said chuck table; and
a blade cover disposed in covering relation to an outer circumference of said cutting blade and having an opening defined in a bottom thereof through which a lower tip end portion of said cutting blade projects,
wherein said blade cover includes
cut dusts retrieving means for retrieving cut dusts produced from the workpiece, said cut dusts retrieving means being disposed on a side of said blade cover toward which the cut dusts scatter upon rotation of said cutting blade when the workpiece is cut by said cutting blade,
said cut dusts retrieving means includes
a tubular member having an end joined to a side wall of said blade cover in which a cut dusts discharge opening is defined, and
a suction source coupled to the other end of said tubular member, and
the workpiece is cut in a dry state by said cutting blade while the cut dusts rotating with said cutting blade in said blade cover are being discharged from the workpiece through said tubular member by actuating said suction source.

2. The cutting apparatus according to claim 1, wherein said blade cover has an air inlet port defined in said bottom thereof between said opening and said cut dusts discharge opening and oriented toward said cut dusts discharge opening,
cut dusts which have been left undrawn into said opening are drawn with surrounding air through said air inlet port to said cut dusts discharge opening.
